(19) United States
(12) Patent Application Publication
(10) Pub. No.: US 2017/0228709 A1
(43) Pub. Date: Aug. 10, 2017

(54) SYSTEM AND METHOD FOR LOCATING NEARBY VEHICLE SERVICE PROVIDERS

(71) Applicant: Harpreet S. Dhaliwal, Cambridge (CA)

(72) Inventor: Harpreet S. Dhaliwal, Cambridge (CA)

(21) Appl. No.: 15/016,428

(22) Filed: Feb. 5, 2016

(51) Int. Cl. G06Q 20/10; H04W 4/02; G07C 5/00

(52) U.S. Cl. CPC G06Q 20/102; G07C 5/008; H04W 4/02; G06Q 50/30

(57) ABSTRACT

A system and method for locating nearby vehicle service providers is disclosed. The method includes obtaining location information from a vehicle operator's mobile device that is used in vehicle breakdown situation to make a service request. The location information is used to determine a list of nearby service providers that are capable of assisting. Preferably, pricing information is provided so that the vehicle operator can select and pay the service provider from the mobile device in order to quickly return the vehicle to operational service.

### FIELD

The present disclosure relates generally to mobile communication devices. More particularly, the disclosure relates to location-based database inquiries in the vehicle service industry, particularly for commercial vehicles.

### BACKGROUND

In the commercial trucking industry mechanical breakdowns result in increased costs and expenses, and also lost productivity. It is important for any logistics organization to minimize these costs and lost productivity by quickly returning the vehicle and driver to service.

In the commercial trucking industry, road-side mechanical breakdowns can be particularly difficult to quickly return a vehicle to service due to a number of issues. Firstly, it can be difficult to locate a vehicle service provider that can quickly get to the road-side breakdown. Another issue is locating a vehicle service provider that has the correct equipment and parts inventory to service the particular type of vehicle. For example, not all towing companies will be able to tow large tonnage tractor-trailers. In a road-side breakdown, comparing prices can also be difficult and very time consuming. There currently does not exist a solution to allow a driver or the company to quickly find and compare prices of vehicle service providers that are near the breakdown and capable of fixing the vehicle.

### SUMMARY

According to a first aspect, a method is provided for locating nearby vehicle service providers, the method comprising obtaining location information from a location service by a mobile device; sending a vehicle service request to a server over a network from the mobile device, the vehicle service request containing the location information; determining a list of nearest vehicle service providers capable of responding to the vehicle service request; providing the list of nearest vehicle service providers to the mobile device; obtaining a selected vehicle servicer provider from the mobile device; and dispatching the selected vehicle service provider. In a further aspect the step of obtaining a selected vehicle service provider can further include receiving a payment confirmation from a payment processor. The list of nearest vehicle service providers can also include pricing or rate information. In some aspects, determining a list of nearest vehicle service providers can match vehicle service provider capabilities with the service request. The vehicle service request can also have a vehicle service request type and can further specify a vehicle part requiring service. The vehicle service request can also contain vehicle identification information obtained by the mobile device, or in some aspects, vehicle diagnostic data, such as fault codes, for example.

In some aspects, a vehicle service provider can have a corresponding mobile device that provides vehicle service provider location information to the server for use in determining the list of nearest vehicle service providers to the location information in the service request. The location information can be provided by a satellite navigation system receiver of the mobile device. In some aspects, a vehicle service provider can have a dispatch device that provides updated service vehicle location information to the server, and the updated service vehicle location information is used to determine the list of nearest vehicle service providers.

According to another aspect, a system is provided for locating nearby vehicle service providers. The system comprises a mobile device having a memory for storing instructions and a processor for executing the instructions to: obtain location information from a location service; send a vehicle service request to a server over a network, the vehicle service request containing the location information; and obtain a selected vehicle servicer provider. The system also comprises a server having a memory for storing instructions and a processor for executing the instructions to determine a list of nearest vehicle service providers capable of responding to the vehicle service request; provide the list of nearest vehicle service providers to the mobile device; and dispatch the selected vehicle service provider.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a block diagram of the functional elements of a mobile computing device;

FIG. 2. is a block diagram of a system for providing vehicle service providers that are nearest to the mobile device; and

FIG. 3 is a flow chart diagram illustrating a method of requesting vehicle service providers that are geographically nearest to the mobile device.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather serves to describe some implementations of possible embodiments.

The embodiments of the systems, devices and methods described herein may be implemented in hardware or software, or a combination of both. Some of the embodiments described herein may be implemented in computer programs executing on a programmable computing device, each computing device comprising at least one processor, a computer memory (including volatile and non-volatile memory), at least one input device, and at least one output device. For example, and without limitation, the programmable computers may have multiple processors and at least one network interface device. Program code may operate on input data to perform the functions described herein and generate output data.

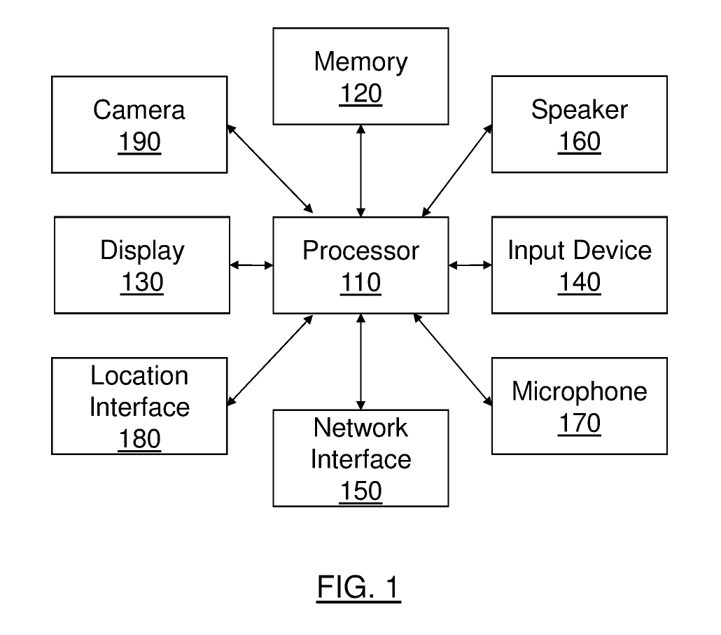

Reference is first made to FIG. 1, shown is a block diagram of a mobile device 100 that can include a processor 110, memory 120, display 130, and input device 140. A network interface 150 can be provided to allow mobile device 100 to communicate with other computing devices over a communication network. Mobile device 100 can further include a speaker 160, a microphone 170, and a camera 190.

Mobile device 100 also includes a location interface 180 that can assist with providing a geographical location of mobile device 100. Location interface 180 can include additional hardware, such as a Global Positioning System (GPS) receiver, for example. Location interface 180 can obtain geographical coordinates using any suitable method known to those skilled in the art, such as using wireless triangulation or Wi-Fi access point databases, for example.

Examples of mobile device 100 can include mobile computing devices, such as mobile phones, laptop computers or tablet computing devices. For example, mobile device 100 can include a smartphone or tablet running an application on an operating system such as, for example, Apple's iOS, Google's Android, or Microsoft's Windows. Other embodiments can include the in-vehicle computer system that may be accessed by an in-dash user interface. Mobile device 100 can also use network interface 150 to communicate with in-vehicle systems to obtain vehicle diagnostics. This could include communicating over a standardized interface bus (e.g. OBDII) for in-vehicle systems or through a short range wireless communications protocol (e.g. Bluetooth).

Mobile device 100, and other computing devices described herein, can store program instructions in memory 120 that when executed by processor 110 carry out the methods described herein. Communication between various computing devices can be made through network interface 150.

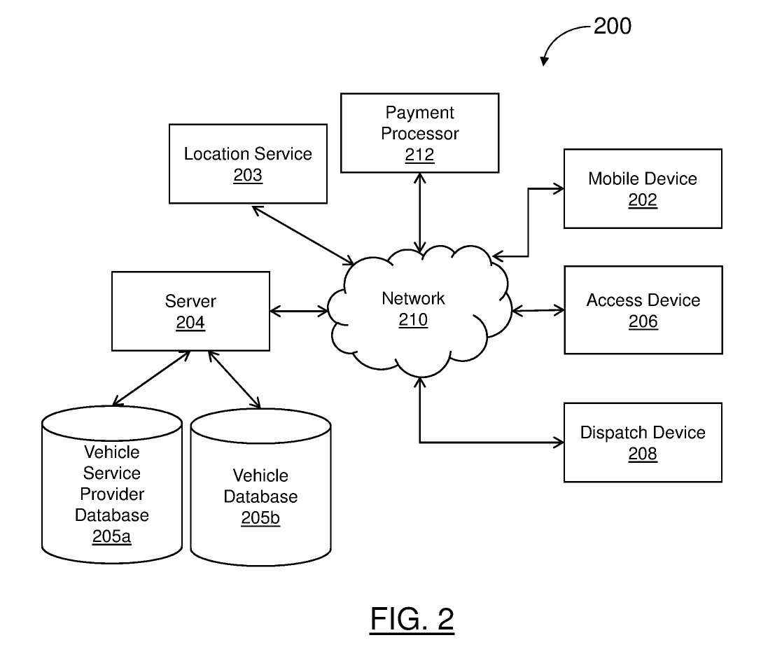

Reference is next made to FIG. 2, shown is a block diagram of a system 200 for providing vehicle service providers that are nearest to a mobile device 202. System 200 can be used in the event of a roadside vehicle breakdown to allow a user of mobile device 202 to obtain service for the vehicle by comparing the prices of various nearby vehicle service providers. Mobile device 202 makes a service request to server 204 that contains location information obtained through the use of location service 203. Server 204 is then able to use the location information to determine a list of nearest vehicle service providers that is provided to mobile device 202 for the user to select.

As noted above, mobile device 202 can be a handheld computing device, such as a mobile phone, tablet, personal digital assistant, media player, or satellite navigation receiver. Mobile device 202 can also include any in-vehicle computing device, such as an in-dash media player or navigation unit. Preferably, mobile device 202 also provides an operating system to allow third-party applications to be executed on mobile device 202. Some embodiments of mobile device 202 can also obtain vehicle diagnostic data from a vehicle, either directly through a connection to an on-board diagnostic bus or through a wireless network interface that is coupled to the vehicle (e.g. a bluetooth or Wi-Fi OBDII adapter). This vehicle diagnostic data can be included in the service request (or subsequent communication between mobile device 202 and server 204) to allow for improved selection of vehicle service providers by server 204. This can include identifying vehicle service providers that are capable of addressing an identified diagnostic trouble code.

Server 204 can be an internet-accessible computing device having a processor, memory and a network interface to access network 210. Preferably, server 204 provides a web service through an HTTP-based web server that can provide communication between mobile device 202, access device 206, and dispatch device 208. Server 204 can include multiple computing devices to provide for redundancy and load balancing, among other system design reasons known in the art.

Server 204 can also be accessed by an access device 206 that can include a computing device having a web browser to authenticate and exchange data with server 204. Access device 206 can allow updating of vehicle or vehicle service provider information stored by server 204. Access device 206 can also include a computing system of a vehicle service provider or vehicle operator that can provide updated information, either periodically or in real-time. For example, vehicle service providers could provide location of tow trucks, available parts inventories, and prices. Vehicle operators could update vehicle data and vehicle service maintenance information (e.g. maintenance intervals and last maintenance date or in-service date of certain vehicle parts).

Vehicle service providers and operators of vehicles register for system 200 with server 204. Registration with server 204 can include setting up an account identifier (e.g. username) and authentication (e.g. a password) that allows access to system 200 over network 210. Examples of network 210 can include the internet and also the internet in combination with other private networks that provide access to the internet, such as, for example, a cellular communication network or a local area network. Preferably, server 204 is hosted on internet to allow wide access to a number of users.

Vehicle service providers register with server 204 and information related to their account is stored in vehicle service provider database 205a. Information stored in vehicle service provider database 205a can include the name and account identification of the vehicle service provider; geographic location information; and service capabilities.

Location information of vehicle service providers can include a static physical service location, such as a garage. Location information for a vehicle service provider can also include location information for a fleet of service vehicles such as to include the geographic location of each available service vehicle in the fleet. For example, a towing company may register with server 204 and provide updated locations of available tow trucks. The availability and location information of each service vehicle can be provided through a dispatch device 208 located in each service vehicle. Dispatch device 208 can be a mobile computing device similar to mobile device 100 and can include mobile phones or in-vehicle computing systems. Dispatch device 208 can send periodic updates of the availability and location information.

Service capabilities can be associated with each vehicle service provider in vehicle service provider database 205a to allow server 204 to match service capabilities with the service required in a service request from a mobile device 202. Example service capabilities can include vehicle types that are serviced, battery/jump-start services, and towing weight capacity. Service capabilities can also include the available parts inventory of the vehicle service provider and compatible vehicles. For example, a vehicle service provider may have a number of batteries in their inventory and each battery can have a number of eligible vehicles. As another example, parts inventories can include tires that the service provider has in stock and the specification for the tires.

Preferably, service capabilities also have an associated rate or price so that a vehicle operator can compare the service cost from various vehicle service providers on mobile device 202. For parts, the rate can include the costs of the part and the required labor. The rate can also be provided as range or estimate for the service capability. In some embodiments, server 204 can provide an application programming interface to allow direct updating of parts inventories or rates with the systems of a vehicle service provider.

Some embodiments of system 200 can also include ratings or reviews that are associated with vehicle service providers. These ratings or reviews can be provided from mobile device 202 after receiving service from a selected vehicle service provider. The ratings and reviews can also be available from mobile device 202 for consideration when deciding upon which vehicle service provider to select.

Vehicle operators, such as drivers or fleet operators, register with server 204 and information related to their account is stored in vehicle database 205b. Information stored in vehicle database 205b can include the name and account identification of the vehicle operator and various vehicle details. Vehicle details can include the vehicle type, the vehicle manufacturer (make), and model number. Other vehicle details stored in vehicle database 205b can include whether the vehicle can be repaired with parts that are not from the original vehicle manufacturer. Server 204 can also include databases to associate vehicles registered in vehicle database 205b with suitable repair parts.

When a vehicle operator registers an account with server 204 vehicle data can be input using mobile device 202 or any access device 206. In the case of a fleet operator, vehicle data can be obtained from the fleet operators system to populate vehicle database 205b. In some embodiments, mobile device 202 can obtain a vehicle identifier (e.g. VIN or vehicle service tag; QR code; transponder code) that identifies the vehicle with the fleet operator, and this vehicle identifier can then be used to obtain data specific to that vehicle from the fleet operators systems.

Other vehicle details stored in vehicle database 205b can include maintenance intervals and service time of the vehicle and the vehicle's various parts. This can be used by server 204 to make service recommendations to vehicle operators to reduce vehicle downtime. For example, if a vehicle is broken down and requires a replacement part and is also nearing a service interval for replacing vehicle fluids, then server 204 can provide a service recommendation at mobile device 202 to replace the vehicle fluids at the same time rather than waiting for an upcoming service interval.

Location information of the vehicle itself can also be periodically updated by server 204 and stored in vehicle database 205b. This location information can be used for tracking the vehicle and assisting with locating the vehicle. Location information can be obtained from a location service 203 over network 210 by mobile device 202. Location service 203 can include a satellite navigation system, such as GPS (wherein network 210 includes over the air satellite communications), and can also work in conjunction with other location services such as Wi-Fi access point based services. Access to location service 203 can be provided to an application executing on mobile device 202 through the operating system running on mobile device.

Dispatch device 208 provides notification to a vehicle service provider to handle a service request. This can include sending a service vehicle or scheduling/reserving a repair bay and required parts. Dispatch device 208 can be any type of communication device known in the art, including telephone, radio or computer systems. For example, server 204 can send an automated voice or text message to dispatch a vehicle service provider.

Dispatch device 208 can also include a mobile computing device, similar to mobile device 202, that is operating the same software application as mobile device 202 but in a vehicle service provider mode. This can allow the application on dispatch device 208 to provide updated location information of the vehicle service provider, set availability to accept a service request, and receive and accept service request notifications on the application.

Mobile device 202 and server 204 can also coordinate the payment of services through the software application on mobile device 202 with the assistance of payment processor 212. A payment confirmation from payment processor 212 can be received prior to server 204 dispatching a vehicle service provider. Payment processor 212 can be an online payment processor such as a credit card processor or PayPal™. Payment processor 212 can also include a software process at server 204 for verifying sufficient funds in a vehicle operator account stored at server 204. For example, vehicle operators can fund their account with system 200 in a number of ways known in the art, but payment processor 212 can verify that there is sufficient funds in the account prior to dispatching a vehicle service request.

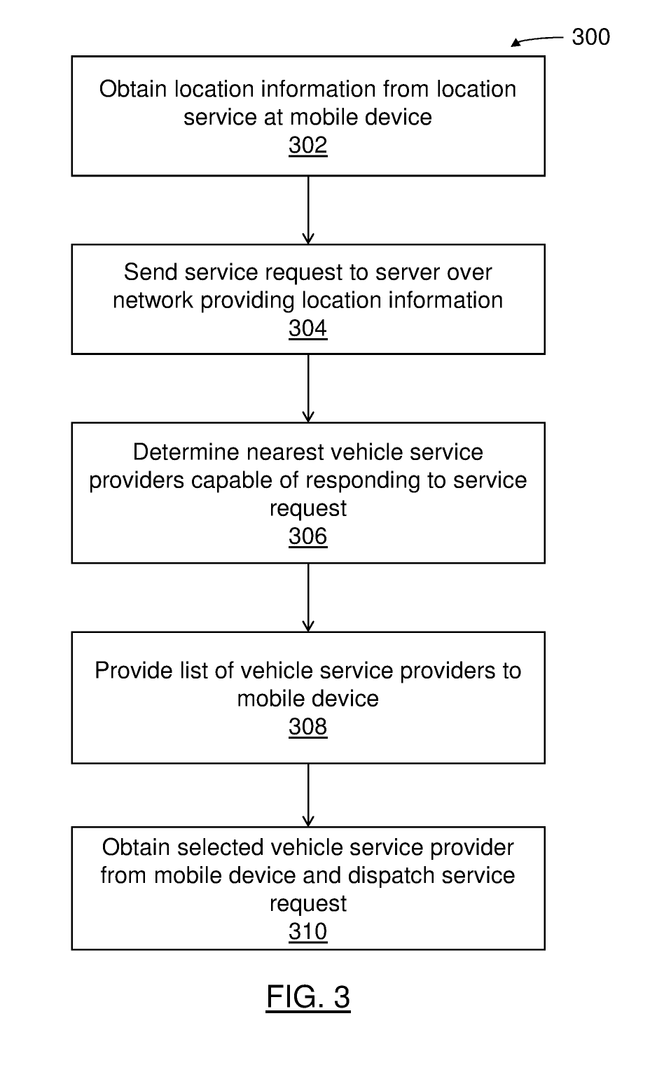

Reference is next made to FIG. 3, shown is a method 300 for providing a list of vehicle service providers that are nearest to the mobile device 202. At step 302 mobile device 202 obtains location information from location service 203. For example, mobile device 202 can include a GPS receiver that provides geographical coordinates (e.g. latitude and longitude) to an application operating on mobile device 202. Next, at step 304, mobile device 202 sends a service request to server 204 over network 210 and can provide location information obtained in step 302. Service request step 304 can be initiated by a vehicle operator when a vehicle breaks down occurs or the vehicle otherwise requires service for continued operation. A vehicle service request can also include a number of communications between mobile device 202 and server 204 to exchange information related to the service request.

Additional information can be provided in the vehicle service request to assist server 204 with identifying appropriate service providers capable of servicing the vehicle. This additional information can include details about the vehicle or the particulars of the break down (e.g. failed part, such as a tire or battery). The vehicle service request can include a request type (e.g. towing, tire replacement, battery jump) or a vehicle part requiring service (and can include a specific part identification). Vehicle identification information can also be obtained by mobile device 202 for providing in the service request, such as a vehicle identification number or other identification with the fleet operator. The vehicle service request can also include vehicle diagnostic data, such as error codes, for example, that can be obtained by the mobile device or other remote vehicle diagnostic system used by a fleet operator.

Next, the location information is used to determine the nearest service providers capable of responding to the service request at step 306. Step 306 can be performed by server 204, mobile device 202, or a combination of both. Nearest service providers can be determined by geographical distance or routing distance using known algorithms. Some embodiments can also use postal or zip codes of vehicle service providers in order to determine which are nearest to the obtained location information. Determining whether a vehicle service provider is capable can include matching service capabilities stored in vehicle service provider database 205a with the capability requirements of the service request. For example, capability matching could include matching a towing capacity with the vehicle weight/type stored in vehicle database 205b. Capability matching can also include whether a vehicle service provider has available resources to service the vehicle such as mechanics, vehicle garage bays, and the appropriate replacement parts.

A list of the nearest capable vehicle service providers are provided at mobile device 202 for selection by the user. Preferably, pricing or rate information is provided with each vehicle service provider. A vehicle operator can then select the preferred vehicle service provider in step 310. Obtaining a selected vehicle service provider on mobile device 202 can include a user selection via a touch screen interface, for example. Upon selection in step 310, mobile device 202 or server 204 can dispatch the vehicle service provider, such as by dispatching a service vehicle to the breakdown location. This can include communicating with a dispatch device 208 of the vehicle service provider.

In some embodiments, selecting a vehicle service provider can further include payment processing prior to dispatch. In these embodiments server 204 can receive a payment confirmation from payment processor 212 in order to dispatch the selected vehicle service provider.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A method for locating nearby vehicle service providers, the method comprising:
obtaining location information from a location service by a mobile device;
sending a vehicle service request to a server over a network from the mobile device, the vehicle service request containing the location information;
determining a list of nearest vehicle service providers capable of responding to the vehicle service request;
providing the list of nearest vehicle service providers to the mobile device;
obtaining a selected vehicle servicer provider from the mobile device; and
dispatching the selected vehicle service provider.

2. The method of claim 1, wherein obtaining a selected vehicle service provider further comprises receiving a payment confirmation from a payment processor.

3. The method of claim 2, wherein the list of nearest vehicle service providers includes pricing information.

4. The method of claim 1, wherein determining a list of nearest vehicle service providers matches vehicle service provider capabilities with the service request.

5. The method of claim 4, wherein the vehicle service request has a vehicle service request type.

6. The method of claim 4, wherein the vehicle service request type specifies a vehicle part requiring service.

7. The method of claim 1, wherein the vehicle service request contains vehicle identification information obtained by the mobile device.

8. The method of claim 7, wherein the vehicle service request contains vehicle diagnostic data.

9. The method of claim 1, wherein at least one vehicle service provider has a corresponding mobile device that provides vehicle service provider location information to the server for use in determining the list of nearest vehicle service providers to the location information in the service request.

10. The method of claim 1, wherein the location service comprises a satellite navigation system receiver of the mobile device.

11. The method of claim 1, wherein the selected vehicle service provider is dispatched to the location information obtained by the mobile device.

12. The method of claim 11, wherein at least one of the vehicle service provider has a dispatch device that provides updated service vehicle location information to the server, and the updated service vehicle location information is used to determine the list of nearest vehicle service providers.

13. A system for locating nearby vehicle service providers, the system comprising:
a mobile device having a memory for storing instructions and a processor for executing the instructions to:
obtain location information from a location service;
send a vehicle service request to a server over a network, the vehicle service request containing the location information; and
obtain a selected vehicle servicer provider
a server having a memory for storing instructions and a processor for executing the instructions to:
determine a list of nearest vehicle service providers capable of responding to the vehicle service request;
provide the list of nearest vehicle service providers to the mobile device; and
dispatch the selected vehicle service provider.
